(19) United States
(12) Patent Application Publication
(10) Pub. No.: US 2025/0293570 A1
(43) Pub. Date: Sep. 18, 2025

(54) COMPRESSOR MOTOR WITH A COOLING SYSTEM

(71) Applicant: Carrier Corporation, Palm Beach Gardens, FL (US)

(72) Inventors: David Okhman, Camillus, NY (US); Yifan Qiu, Manlius, NY (US)

(21) Appl. No.: 19/063,487

(22) Filed: Feb. 26, 2025

Related U.S. Application Data
(60) Provisional application No. 63/566,476, filed on Mar. 18, 2024.

(51) Int. Cl. H02K 9/19; F04C 18/16; F25B 31/00; F25B 31/02; H02K 7/00

(52) U.S. Cl. CPC H02K 9/19; F25B 31/008; F25B 31/026; H02K 7/003; F04C 18/16

(57) ABSTRACT

Described herein is a motor for a compressor. The motor comprises a rotor configured over a shaft, a stator arranged around the rotor within a housing associated with the compressor, and a cooling system. The cooling system comprises a first fluidic passage extending from a first end towards a second end, along a length, of the shaft, and a plurality of orifices configured at positions on a circumference of the shaft, where the plurality of orifices are fluidically connected to the first fluidic passage via a plurality of second fluidic passages, wherein the motor is configured to enable a refrigerant associated with the compressor to flow within the first fluidic passage via the first end of the shaft and further flow out of the shaft towards the stator and/or the rotor through the plurality of orifices via the corresponding second fluidic passages.

### CROSS-REFERENCE TO RELATED APPLICATION

This patent application claims the benefit of U.S. Provisional Patent Application No. 63/566,476, filed on Mar. 18, 2024, which is incorporated by reference herein in its entirety.

### BACKGROUND

This subject disclosure relates to the field of electric motors for compressors, and more particularly, a compressor motor with a cooling system.

### SUMMARY

Described herein is a motor for a compressor. The motor comprises a rotor configured over a shaft, a stator arranged around the rotor within a housing associated with the compressor, and a cooling system. The cooling system comprises a first fluidic passage extending from a first end towards a second end, along a length, of the shaft, and a plurality of orifices configured at positions on a circumference of the shaft, where the plurality of orifices are fluidically connected to the first fluidic passage via a plurality of second fluidic passages, wherein the motor is configured to enable a refrigerant associated with the compressor to flow within the first fluidic passage via the first end of the shaft and further flow out of the shaft towards the stator and/or the rotor through the plurality of orifices via corresponding second fluidic passages from the plurality of fluidic passages.

In one or more embodiments, the first fluidic passage is non-parallel to a central axis of the shaft and the plurality of second fluidic passages extend outwards from the first fluidic passage in a radial direction from the central axis.

In one or more embodiments, the first fluidic passage is non-parallel to the central axis such that a first end of the first fluidic passage remains at a center of the first end of the shaft and a second end of the first fluidic passage extends at an angle from the central axis towards the second end of the shaft.

In one or more embodiments, the first fluidic passage is non-parallel to the central axis such that rotation of the shaft about the central axis during operation of the compressor causes the received refrigerant to flow or spray out of the plurality of orifices via the plurality of second fluidic passages.

In one or more embodiments, the motor or the cooling system comprises a nozzle disposed within the housing, wherein the nozzle comprises: an inlet fluidically connected to a refrigerant line or refrigerant flow path associated with the compressor, to receive at least a portion of the refrigerant flowing through the compressor. The nozzle further comprises an outlet connected to the inlet of the nozzle, wherein the outlet of the nozzle remains/is at a gap from an opening of the first fluidic passage at the first end of the shaft, such that the nozzle sprays the received refrigerant into the first fluidic passage of the shaft while allowing the shaft to rotate without coming in contact with the nozzle.

In one or more embodiments, an exterior body at an end of the nozzle has a notch-shaped profile, and wherein the first end of the shaft comprises a recess concurrent to and adapted to receive the notch-shaped end of the nozzle therein to create a labyrinth seal therebetween, such that the nozzle sprays the received refrigerant into the first fluidic passage of the shaft while allowing the shaft to rotate without coming in contact with the notch-shaped end of the nozzle.

In one or more embodiments, the housing of the motor comprises a third fluidic passage drilled therethrough and fluidically connected to the inlet of the nozzle, to enable the supply of the refrigerant associated with the compressor within the housing or into the nozzle or the shaft.

In one or more embodiments, the second end of the first fluidic passage is closed.

In one or more embodiments, a diameter of the first fluidic passage is greater than a diameter of the plurality of second fluidic passages.

In one or more embodiments, the plurality of orifices comprises a first set of orifices provided along the circumference at the first end of the shaft, and a second set of orifices provided along the circumference at the second end of the shaft.

In one or more embodiments, the first set of orifices is adjacent to a first end of a stator winding associated with the stator, and the second set of orifices is adjacent to a second end of the stator winding.

In one or more embodiments, the first set of orifices is adjacent to a first end of the rotor, and the second set of orifices is adjacent to a second end of the rotor.

In one or more embodiments, a diameter of the first set of orifices provided at the first end of the shaft is greater than a diameter of the second set of orifices provided at the second end of the shaft.

In one or more embodiments, a diameter of the plurality of second fluidic passages at the first end of the shaft is greater than a diameter of the plurality of second fluidic passages at the second end of the shaft.

In one or more embodiments, the plurality of orifices comprises one or more pairs of first orifices provided along the circumference at the first end of the shaft, wherein first orifices associated with each of the one or more pairs of first orifices are opposite to each other, and one or more pairs of second orifices provided along the circumference at the second end of the shaft, wherein second orifices associated with each of the one or more pairs of second orifices are opposite to each other.

In one or more embodiments, the plurality of orifices comprises a first set of orifices provided along the circumference at the first end of the shaft at one or more of 0-degree angle, 45-degree angle, 90-degree angle, 135-degree angle, 180-degree angle, 225-degree angle, 270-degree angle, and 315-degree angle from a reference plane extending along a center of the shaft, and a second set of orifices provided along the circumference at the second end of the shaft at one or more of 0-degree angle, 45-degree angle, 90-degree angle, 135-degree angle, 180-degree angle, 225-degree angle, 270-degree angle, and 315-degree angle from the reference plane.

In one or more embodiments, the compressor is a screw compressor associated with a vapor compression system.

In one or more embodiments, the housing of the motor comprises a drain area configured to receive and collect the refrigerant drained from the stator and/or the rotor.

In one or more embodiments, the motor is configured to enable supply of the drained refrigerant into a liquid drain line associated with the compressor.

In one or more embodiments, the liquid drain line is further connected to an evaporator being fluidically connected to the compressor in a refrigerant line, and wherein the nozzle is fluidically connected to a liquid injection line connected to a condenser being fluidically connected to the compressor in the refrigerant line.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates an exemplary side cross-sectional view of the motor associated with a compressor, where the motor is equipped with an in-built cooling system in accordance with one or more embodiments of the subject disclosure.

FIG. 1B illustrates an exemplary representation depicting the flow of refrigerant within the motor of FIG. 1A in accordance with one or more embodiments of the subject disclosure.

FIG. 2 illustrates an exemplary representation of a refrigerant line associated with the compressor of FIG. 1A in accordance with one or more embodiments of the subject disclosure.

FIGS. 3A to 3D illustrates exemplary front cross-sectional view of the rotor shaft depicting the position of various orifices, in accordance with an embodiment of the present disclosure.

FIG. 4 illustrates an exemplary view depicting the fluidic engagement of the nozzle within the first end of the rotor shaft, in accordance with an embodiment of the present disclosure

### DETAILED DESCRIPTION

The following is a detailed description of embodiments of the subject disclosure depicted in the accompanying drawings. The embodiments are in such detail as to clearly communicate the subject disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

Electric motors are integral components in a wide array of applications, notably in refrigeration, and air conditioning systems where they are configured with compressors. In these systems, the electric motor is tasked with driving the compressor, which results in substantial heat generation due to electrical and mechanical losses within the motor. If this heat is not adequately dissipated, the motor's temperature may exceed the rated limits set by the manufacturer, potentially leading to inefficiency, reduced performance, and even premature failure of the motor or the entire system.

The challenge of effectively cooling electric motors is exacerbated in configurations where the motor is closely integrated with a compressor. The compact nature of such configurations, while beneficial for saving space and improving system integration, limits the options for implementing traditional cooling solutions and complicates the thermal management strategy.

Therefore, there exists a need for an improved cooling system for electric motors in compressor-integrated applications, which may achieve even and effective cooling of the motor while accommodating the physical and operational constraints of motor-compressor assemblies.

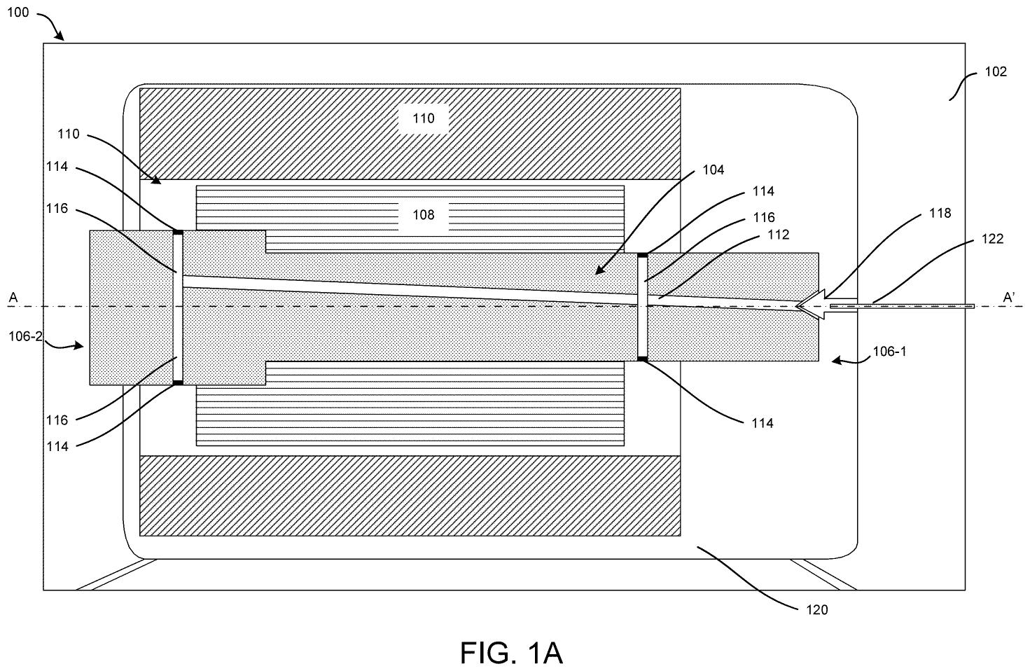

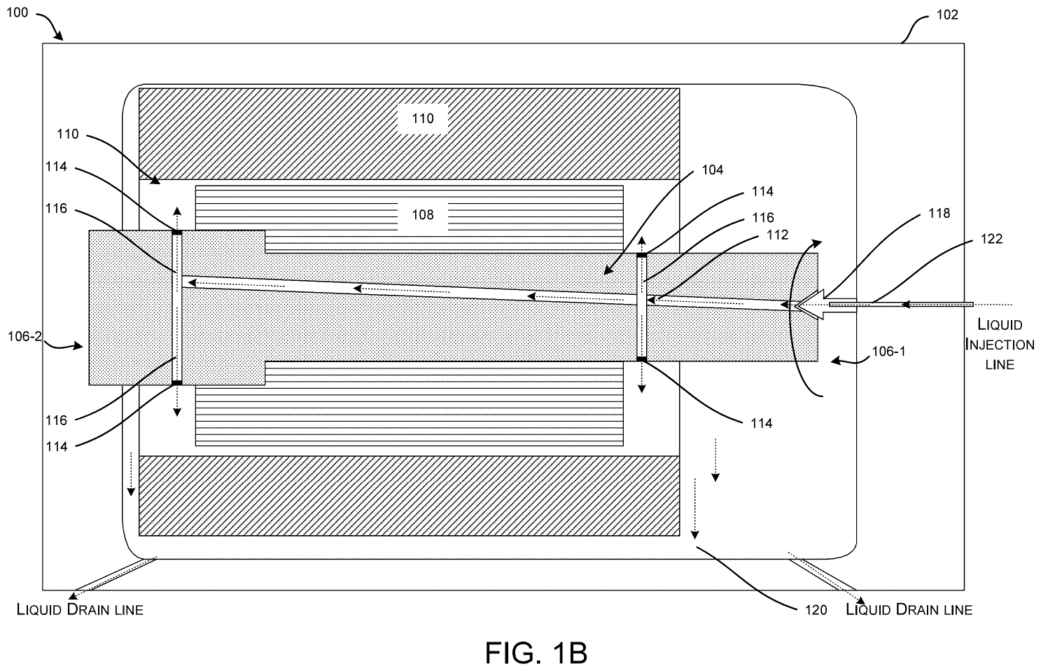

Referring to FIGS. 1A and 1B, an electric motor 100 (also referred to as a motor 100, herein) associated with a compressor is disclosed. In one or more embodiments, the compressor may be a screw compressor associated with a vapor compression system, but not limited to the like, where the motor 100 may be integrated within the housing 102 of the compressor. However, in other embodiments, the motor 100 may have a separate housing that may be fluidically connected to the housing 102 of the compressor.

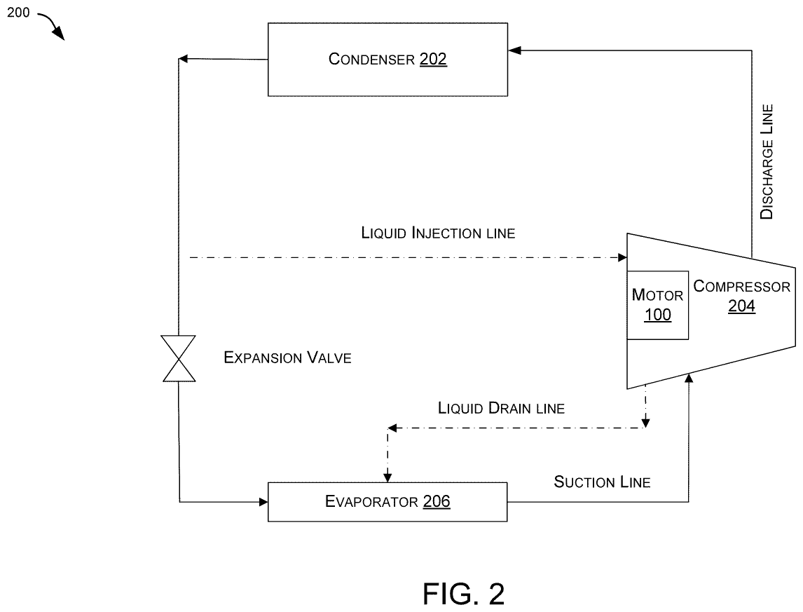

In one or more embodiments, the motor 100 may include a rotor 108 mounted over and locked to a shaft 104, where the rotor 108 may be configured to rotate about a central axis A-A′ along with the shaft 104. The electric motor 100 may further include a stator 110 including a stator stack having a plurality of stator windings arranged around the rotor 108, with the stator windings being fixedly positioned within a housing 102 associated with the motor 100 or compressor. The electric motor 100 may be configured to be electrically connected to a power supply that may provide electric current to the stator windings to induce an electromagnetic field within the stator windings, resulting in a rotational motion of the rotor 108 about the central axis A-A′. The motor 100 may further include a cooling system that may include a first fluidic passage 112 extending from a first end (non-driving end) 106-1 towards a second end 106-2, along the length, of the shaft 104. The cooling system may further include a plurality of orifices 114 configured at different positions on the circumference of the shaft 104. Further, the plurality of orifices 114 may be fluidically connected to the first fluidic passage 112 via a plurality of second fluidic passages 116-1 to 116-N (collectively designated as 116, herein). In one or more embodiments, the second end (at the end 106-2) of the first fluidic passage 112 associated with the shaft 104 may be closed such that the shaft 104 may receive a fluid therein via the first end (at the end 106-1) and further supply the received fluid out of the orifices 114 via the second fluidic passages 116. However, in some embodiments, the second end of the first fluidic passage 112 may also be open. In one or more embodiments, the motor 100 may be configured to enable a refrigerant (fluid) associated with the compressor (such as compressor 204 as shown in FIG. 2) to flow within/into the first fluidic passage 112 via the first end 106-1 of the shaft 104 and further flow out of the shaft 104 towards the stator 110 and/or the rotor 108 through the orifices 114 via the corresponding second fluidic passages 116.

In one or more embodiments, the first fluidic passage 112 may be non-parallel to the central axis A-A′ of the shaft 104 with the second fluidic passages 116 extending outward from the first fluidic passage 112 in a radial direction from the central axis A-A′. The first fluidic passage 112 may be non-parallel to the central axis A-A′ such that a first end of the first fluidic passage 112 remains/is at the center of the first end 106-1 of the shaft 104 and a second end of the first fluidic passage 112 extends at an angle from the central axis A-A′ towards the second end 106-2 of the shaft 104. Further, in some embodiments, the second fluidic passages 116 may extend radially outwards from the non-parallel first fluidic passage 112 and not necessarily from the central axis A-A′ of the shaft 104. Accordingly, as the first fluidic passage 112 is non-parallel to the central axis A-A′ of the shaft 104, the rotation of the shaft 104 about the central axis A-A′ during the operation of the compressor may cause the refrigerant received within the first fluidic passage 112 to automatically flow or spray out of the orifices 114 via the second fluidic passages 116 under the centrifugal force of the shaft 104 and a pressure differential between an inlet of the first fluid passage 112 and the orifices 114 as shown in FIG. 1B. Besides, there is no need for additional coolant, or a pump to drive this coolant through the motor 100's cooling system, or an additional reservoir to store this coolant in this subject disclosure (as the motor 100 uses the same refrigerant flowing through the compressor) to cool the motor 100. This helps make the overall motor 100 and compressor assembly efficient and compact.

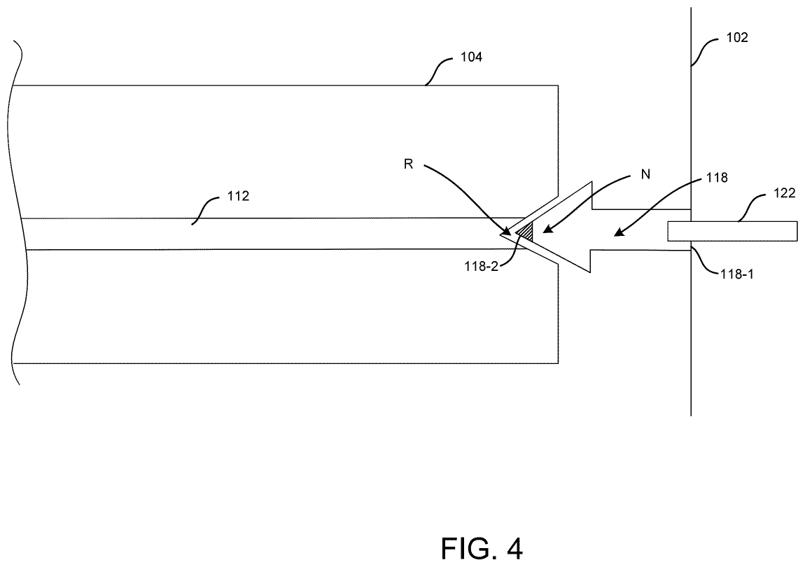

In one or more embodiments, the motor 100 or the cooling system may include a nozzle 118 disposed within the housing 102. The nozzle 118 may include an inlet 118-1 (as shown in FIG. 4) fluidically connected to a refrigerant line or refrigerant flow path associated with the compressor, to receive at least a portion of the refrigerant flowing through the compressor. The nozzle 118 may further include an outlet 118-2 (as shown in FIG. 4) connected to the inlet 118-1 of the nozzle 118. In one or more embodiments, the housing 102 of the motor 100 may include a third fluidic passage 122 drilled therethrough and fluidically connected to the inlet 118-1 of the nozzle 118, to enable the supply of the refrigerant associated with the compressor within the housing 102 or into the nozzle 118 or the shaft 104. Accordingly, the operation of the compressor may cause the refrigerant received within the first fluidic passage 112 to automatically flow or spray out of the orifices 114 via the second fluidic passages 116 under the centrifugal force of the shaft 104 and a pressure differential between outlet 118-2 of the nozzle 118 and the orifices 114 on the shaft 104.

The nozzle 118 may be disposed within the housing 102 such that the outlet 118-2 of the nozzle 118 remains/is separated by a gap from an opening of the first fluidic passage 112 at the first end 106-1 of the shaft 104, whereby the nozzle 118 may spray the received refrigerant into the first fluidic passage 112 of the shaft 104 while allowing the shaft 104 to rotate without coming in contact with the nozzle 118. This may allow the rotor 108 to freely rotate about the axis A-A′ without any hindrance and also receive the refrigerant from the nozzle 118.

Referring to FIG. 4, in one or more embodiments, an outer surface, at an outlet end, of the nozzle 118 may have a notch-shaped profile N, and the other end, at the inlet 118-1, of the nozzle 118 may be disposed within the third fluidic passage 122 drilled in the housing 102 of the motor 100. Further, the first end 106-1 of the shaft 104 may include a recess R concurrent to the notch-shaped profile N of the outlet 118-2 of the nozzle 118. This recess R may be adapted to receive the notch-shaped end N of the nozzle 118 therein to create a labyrinthine seal therebetween, such that the nozzle 118 may spray the received refrigerant into the first fluidic passage 112 of the shaft 104 with minimal or no leakage while allowing the shaft 104 to rotate without coming in contact with the notch-shaped end of the nozzle 118.

Referring back to FIG. 1A and 1B, in one or more embodiments, the housing 102 of the motor 100 may include a drain area 120 configured at the bottom to receive and collect the refrigerant drained from the stator 110 and/or the rotor 108, along with any refrigerant leaked within the motor 100. Further, the motor 100 may be configured to enable the supply of the drained refrigerant into a liquid drain line associated with the compressor or a refrigerant line in which the compressor is employed.

Referring to FIG. 2, the liquid drain line may be further connected to an evaporator 206 being fluidically connected to the compressor 204 in the refrigerant line. Further, the nozzle 118 or third fluidic passage 122 provided in the housing 102 may be fluidically connected to a liquid injection line connected to a condenser 202, the condenser 202 being fluidically connected to the compressor 204 in the refrigerant line 200. Accordingly, the cooling system of the motor 100 may receive cool liquid refrigerant from the condenser 202 via the liquid injection line, and further supply the refrigerant collected within the motor's housing 102 back to the refrigerant line (via the drain line) along with the vapor-phase of the refrigerant (formed within the compressor 204).

In one or more embodiments, the diameter of the first fluidic passage 112 may be greater than the diameter of the second fluidic passages 116. However, in other embodiments, the diameter of the first fluidic passage 112 may also be equal to or less than the diameter of the second fluidic passages 116. This may allow the cooling system to maintain the flow of the refrigerant through the shaft 104 while spraying a jet of the refrigerant, via the orifices 114, towards the stator 110 and the rotor 108.

In one or more embodiments, the plurality of orifices 114 may include a first set of orifices provided along the circumference at the first end 106-1 of the shaft 104, and a second set of orifices provided along the circumference at the second end 106-2 of the shaft 104, such that the orifices 114 are adjacent to both the sides of the stator 110 and the rotor 108, allowing the refrigerant to be effectively and efficiently supplied to the stator 110 and the rotor 108. For instance, in one or more embodiments, the first set of orifices may be adjacent to a first end of the stator winding associated with the stator 110, and the second set of orifices may be adjacent to a second end of the corresponding stator winding. Further, in some embodiments, the first set of orifices may be adjacent to a first end of the rotor 108, and the second set of orifices is adjacent to a second end of the rotor 108.

Further, in one or more embodiments, the diameter of the first set of orifices 114 provided at the first end (refrigerant entry side) 106-1 of the shaft 104 may be greater than the diameter of the second set of orifices 114 provided at the second end (refrigerant exit side) 106-2 of the shaft 104. However, in other embodiments, the diameter of the first set of orifices 114 provided at the first end (refrigerant entry side) 106-1 of the shaft 104 may also be equal to the diameter of the second set of orifices 114 provided at the second end 106-2 of the shaft 104. Similarly, in one or more embodiments, the diameter of the second fluidic passages 116 provided at the first end (refrigerant entry side) 106-1 of the shaft 104 may be greater than the diameter of the second fluidic passages 116 provided at the second end 106-2 of the shaft 104. This arrangement may allow the cooling system to enable uniform and equal flow of the refrigerant out of all the orifices 114.

In one or more embodiments, the plurality of orifices 114 may include one or more pairs of first orifices provided along the circumference at the first end 106-1 of the shaft 104, such that the first orifices associated with each of the pairs remain or are defined opposite to each other. Further, the plurality of orifices 114 may include one or more pairs of second orifices provided along the circumference at the second end 106-2 of the shaft 104, such that the second orifices associated with each of the pairs remain or are defined opposite to each other, i.e., on opposite surfaces of the shaft 104. However, in other embodiments, the number of orifices 114 on the shaft 104 may be one, in pairs, or multiple at one axial location (without being opposite to each other), and all such embodiments are well within the scope of the subject disclosure.

In one or more embodiments, the first set of orifices provided along the circumference at the first end 106-1 of the shaft 104 are at one or more of 0-degree angle, 45-degree angle, 90-degree angle, 135-degree angle, 180-degree angle, 225-degree angle, 270-degree angle, and 315-degree angle from a reference plane P extending along a center of the shaft 104. Similarly, the second set of orifices provided along the circumference at the second end 106-2 of the shaft 104 may be at one or more of 0-degree angle, 45-degree angle, 90-degree angle, 135-degree angle, 180-degree angle, 225-degree angle, 270-degree angle, and 315-degree angle from the reference plane of the shaft 104.

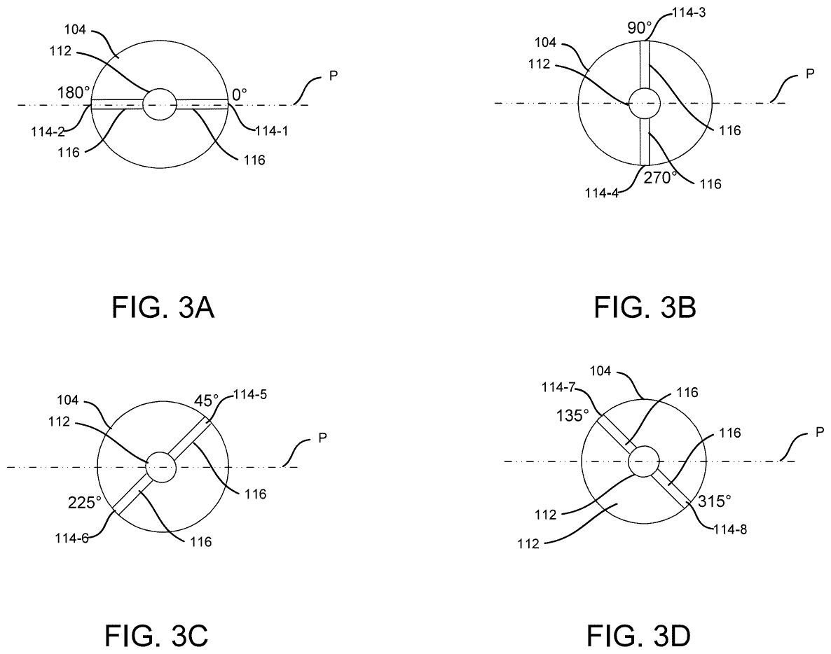

Referring to FIG. 3A to 3D, in one or more embodiments, a pair of orifices 114-1, 114-2 may be at 0-degree and 180-degree angles, another pair of orifices 114-3, 114-4 may be provided at 90-degree and 270-degree angles, another pair of orifices 114-5, 114-6 may be provided at 45-degree and 225-degree angles, and another pair of orifices 114-7, 114-8 may be provided at 135-degree and 315-degree angles from the reference plane P at the end 106-1 and/or the second end 106-2 of the shaft 104. These orifices 114-1 to 114-8 may be fluidically connected to the first fluidic passage 112 via the second fluidic passages 116, where the second fluidic passages 116 may radially extend from the first fluidic passage 112 towards the corresponding orifices 114. While various embodiments and drawings have been described herein for the shaft 104, having the pair of orifices 114 opposite or 180 degrees from each other at a specific location to help balance the shaft 104, however, the pair of orifices 114 may be at a specific location but not necessarily be 180 degrees from each other. In addition, the orifices may not be in pairs at each location, however, there may be only one orifice drilled to the center passage 112, and all such embodiments are well within the scope of the subject disclosure.

While various embodiments herein have been described for the motor 100 associated with a screw compressor, however, the teaching of the subject disclosure is equally applicable to motors associated with other types of compressor as well as for motors associated with non-compressor based applications, without any limitations, and all such embodiments are well within the scope of this subject disclosure.

It is to be appreciated by a person skilled in the art that keeping the first fluidic passage 112 non-parallel to the central axis A-A′ of the shaft 104 may cause the refrigerant received within the first fluidic passage 112 to automatically flow or spray out of the orifices 114 via the second fluidic passages 116 under a centrifugal force created upon rotation of the shaft 104 about the central axis A-A′ and due to a pressure differential created between the nozzle outlet 118-2 and the orifices 114 during operation of the compressor 204. Moreover, the use of the same refrigerant (flowing through the compressor 204) to cool the motor 100 makes the overall motor 100 and compressor assembly efficient and compact, as there is no need for additional coolant, a pump to drive this coolant through the motor 100's cooling system, and an additional reservoir to store this coolant.

Thus, this subject disclosure overcomes the challenges associated with existing motor cooling systems associated with compressors as well as in general, by providing an improved cooling system for electric motors in compressor-integrated applications. The subject disclosure may achieve even and effective cooling of the motor while accommodating the physical and operational constraints of motor-compressor assemblies.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A motor for a compressor, the motor comprising:
a rotor configured over a shaft;
a stator arranged around the rotor within a housing associated with the compressor; and
a cooling system comprising:
a first fluidic passage extending from a first end towards a second end, along a length, of the shaft; and
a plurality of orifices configured at positions on a circumference of the shaft, wherein the plurality of orifices is fluidically connected to the first fluidic passage via a plurality of second fluidic passages,
wherein the motor is configured to enable a refrigerant associated with the compressor to flow within the first fluidic passage via the first end of the shaft and further flow out of the shaft towards the stator and/or the rotor through the plurality of orifices via corresponding second fluidic passages from the plurality of second fluidic passages.

2. The motor of claim 1, wherein the first fluidic passage is non-parallel to a central axis of the shaft and the plurality of second fluidic passages extends outwards from the first fluidic passage in a radial direction from the central axis.

3. The motor of claim 2, wherein the first fluidic passage is non-parallel to the central axis such that a first end of the first fluidic passage remains at a center of the first end of the shaft and a second end of the first fluidic passage extends at an angle from the central axis towards the second end of the shaft.

4. The motor of claim 2, wherein the first fluidic passage is non-parallel to the central axis such that rotation of the shaft about the central axis during operation of the compressor causes the received refrigerant to flow out of the plurality of orifices via the plurality of second fluidic passages.

5. The motor of claim 1, wherein the motor or the cooling system comprises a nozzle disposed within the housing, and wherein the nozzle comprises:
an inlet fluidically connected to a refrigerant line associated with the compressor, to receive at least a portion of the refrigerant flowing through the compressor; and
an outlet connected to the inlet of the nozzle, wherein the outlet of the nozzle is at a gap from an opening of the first fluidic passage at the first end of the shaft, such that the nozzle sprays the received refrigerant into the first fluidic passage of the shaft while allowing the shaft to rotate without coming in contact with the nozzle.

6. The motor of claim 5, wherein an exterior body at an end of the nozzle has a notch-shaped profile, and wherein the first end of the shaft comprises a recess concurrent to and adapted to receive the notch-shaped end of the nozzle therein to create a labyrinthine seal therebetween, such that the nozzle sprays the received refrigerant into the first fluidic passage of the shaft while allowing the shaft to rotate without coming in contact with the notch-shaped end of the nozzle.

7. The motor of claim 5, wherein the housing of the motor comprises a third fluidic passage drilled therethrough and fluidically connected to the inlet of the nozzle, to enable the supply of the refrigerant associated with the compressor within the housing or into the nozzle or the shaft.

8. The motor of claim 3, wherein the second end of the first fluidic passage is closed.

9. The motor of claim 1, wherein a diameter of the first fluidic passage is greater than a diameter of the plurality of second fluidic passages.

10. The motor of claim 1, wherein the plurality of orifices comprises a first set of orifices provided along the circumference at the first end of the shaft, and a second set of orifices provided along the circumference at the second end of the shaft.

11. The motor of claim 10, wherein the first set of orifices is adjacent to a first end of a stator winding associated with the stator, and the second set of orifices is adjacent to a second end of the stator winding.

12. The motor of claim 10, wherein the first set of orifices is adjacent to a first end of the rotor, and the second set of orifices is adjacent to a second end of the rotor.

13. The motor of claim 10, wherein a diameter of the first set of orifices provided at the first end of the shaft is greater than a diameter of the second set of orifices provided at the second end of the shaft.

14. The motor of claim 1, wherein a diameter of the plurality of second fluidic passages at the first end of the shaft is greater than a diameter of the plurality of second fluidic passages at the second end of the shaft.

15. The motor of claim 1, wherein the plurality of orifices comprises:
one or more pairs of first orifices provided along the circumference at the first end of the shaft, wherein first orifices associated with each of the one or more pairs of first orifices are opposite to each other; and
one or more pairs of second orifices provided along the circumference at the second end of the shaft, wherein second orifices associated with each of the one or more pairs of second orifices are opposite to each other.

16. The motor of claim 1, wherein the plurality of orifices comprises:
a first set of orifices provided along the circumference at the first end of the shaft at one or more of: 0-degree angle, 45-degree angle, 90-degree angle, 135-degree angle, 180-degree angle, 225-degree angle, 270-degree angle, and 315-degree angle from a reference plane extending along a center of the shaft; and
a second set of orifices provided along the circumference at the second end of the shaft at one or more of: 0-degree angle, 45-degree angle, 90-degree angle, 135-degree angle, 180-degree angle, 225-degree angle, 270-degree angle, and 315-degree angle from the reference plane.

17. The motor of claim 1, wherein the compressor is a screw compressor associated with a vapor compression system.

18. The motor of claim 1, wherein the housing of the motor comprises a drain area configured to receive and collect the refrigerant drained from the stator and/or the rotor.

19. The motor of claim 1, wherein the motor is configured to enable supply of the refrigerant drained from the stator and/or the rotor into a liquid drain line associated with the compressor.

20. The motor of claim 19, wherein the liquid drain line is further connected to an evaporator being fluidically connected to the compressor in a refrigerant line, and wherein the nozzle is fluidically connected to a liquid injection line connected to a condenser being fluidically connected to the compressor in the refrigerant line.
